(19) United States
(12) Patent Application Publication
(10) Pub. No.: US 2010/0195860 A1
(43) Pub. Date: Aug. 5, 2010

(54) SOFT SHELL IN-EAR EARPHONES WITH MINIATURE SPEAKER INSERTS

(76) Inventor: Cher Becker, Bridge City, TX (US)

Correspondence Address: DONALD W. MEEKER, 924 EAST OCEAN FRONT, # E, NEWPORT BEACH, CA, 92661, US

(21) Appl. No.: 12/366,640

(22) Filed: Feb. 5, 2009

(51) Int. Cl. H04R 25/00

(52) U.S. Cl. 381/371

(57) ABSTRACT

A set of in-ear earphones has two outer shaped soft foam shell ear plugs each having a bulbous insert head with a sound hole and flared outer rim separated by a narrow waist. Each has an inserted miniature sound emitter supported by a firm foam insert engaging with the narrow waist. The foam insert and sound emitter are used to push the earphone into the ear canal. The outer rim is used to withdraw the earphone. The miniature sound emitter is connected to a wire that connects to a sound jack plug or a wireless sound receiver.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to earphones and particularly to a set of in-ear earphones comprising two outer shaped soft foam shell earphones each having a bulbous insert head and flared outer rim separated by a narrow waist, each with an inserted miniature speaker supported by a firm foam insert engaging with the narrow waist, wherein the foam insert is used to push the earphone into the ear canal and the outer rim is used to withdraw the earphone, and wherein the miniature sound emitter is connected to a wire that connects to a sound jack plug or a wireless sound receiver.

2. Description of Related Art Including Information Disclosed Under 37 CFR 1.97 and 1.98

Earbuds or in-ear earphones are common electric devices for a user to listen to the sounds output from audio facilities by plugging them into an iPod, MP3 player, CD player, DVD player, mobile phone, or other sound producing device. The prior art in-ear earphones are often uncomfortable due to a rigid exterior shape which often does not fit properly in the ear canal and is prone to falling out. Furthermore, ill-fitting hard surface in-ear earphones do not block adequately block external sound which can interfere with listening to what is played through the in-ear earphones.

U.S. Patent Application #20080245372, published Oct. 9, 2008 by Smith, is for a reusable foam ear insert. The ear insert can comprise a foam body and a non-foam covering. The foam body can, for example, comprise foam rubber. The covering can, for example, comprise vinyl. The body is configured to be at least partially received within the ear canal and can be generally bullet shaped. The combination of the body and the covering can provide hearing protection. An optional bore can facilitate use in communications. The covering is resistant to soiling and is easily cleaned, thus facilitating reuse of the ear insert.

U.S. Patent Application #20080187161, published Aug. 7, 2008 by Tiemens et al, shows an earbud for carrying sound from a source to a person's ear canal, which includes a soft foam body and a sleeve of stiffer material lying within the body. The body is molded around the sleeve and is chemically bonded to the sleeve without an adhesive between them. The earbud is molded around the sleeve by placing the sleeve on a mandrel pin within a mold cavity, placing foamable material in the mold and closing the mold. The mold has shoulders with one mold shoulder that abuts one end of the sleeve and another mold shoulder that lies within 0.1 millimeter of the other sleeve end, to prevent foaming material from leaking into the space between the mandrel pin and the sleeve passage.

U.S. Patent Application #20080152163, published Jun. 26, 2008 by Mulvey, claims an earbud coupling that has a rear portion forming an earbud mount that easily attaches to a hemispherical earbud, and which has a front portion forming an in-ear mount that can be pressed into a person's ear canal to hold the coupling to the person while blocking environmental noise. The earbud mount includes a tapered elastomeric sleeve with an internal groove at its rear end. The earbud mount rear end can be expanded to fit around the periphery of the earbud front end to securely attach to the earbud. A plurality of different in-ear mounts or tips can be provided that each can be attached to the front end of the earbud mount, including an in-ear mount that consists of a single integral elastomeric member with at least one flange. The earbud mount and in-ear mount can be connected by a shaft with pair of projections on one of the mounts that is inserted into a hole with slots of the other one and turned.

U.S. Patent Application #20060213524, published Sep. 28, 2006 by Woo et al, describes a method for forming a device that fits into a person's ear canal, that carries sound from a pipe of a speaker assembly into the person's ear canal, and that blocks environmental noise. A first elastomeric material is molded around an elongated core to form a device body with an outer surface that can seal to a person's ear canal. In one method, the first elastomeric material of the body is a soft foamable material and the core is a previously-formed tube of a stiffer second elastomeric material, with the body bonded to the tube by being molded around it, either in a mold cavity or by extrusion through an extrusion head. In another method, the elastomeric material of the body is a non-foam, and the core is a rigid pin that is removed from the earplug body after the earplug body has at least partially solidified.

U.S. Pat. No. 5,002,151, issued Mar. 26, 1991 to Oliveira et al, is for an ear piece having a disposable, compressible polymeric foam sleeve which is used on hearing aids or any sound transmission device, such as ear phones, audio or transcription headsets, and the like. Disposably attached to the ear piece of a hearing aid, which includes any sound transmission device, is a user-disposable sleeve comprising soft polymeric retarded recovery foam that can be compressed to be freely insertable into a person's ear and allowed to recover to become wedged in the canal. Preferably, the sleeve is disposably attached to the ear piece by mating of screw threads on the sleeve and the ear piece. The ear piece may be a separate component from the hearing aid. The component is made either of rigid or flexible plastic and has connecting portions of various lengths depending on the depth of insertion of the sleeve into the canal. The sleeve may be of various lengths depending on the depth of insertion into the ear canal desired. The sleeve/ear piece assembly may also have a layer of sound transmitting scrim over its central opening to minimize penetration of the connecting portion past the end of the sleeve.

U.S. Pat. No. 5,203,352, issued Apr. 20, 1993 to Gardner, Jr., provides polymeric foam protective earplug constructions of the roll-down type. In one aspect the constructions employ means to limit the depth of insertion of the earplug into the ear canal and to facilitate proper insertion thereof. In another aspect, the constructions employ polymeric foam bodies adapted to be compressed, inserted into the ear canal and there allowed to expand to obturate the ear canal and whose recovery time is markedly and inversely temperature dependent. The earplug can be employed effectively an earphone device wherein an earplug such as described hereinbefore is modified by providing it with an axial bore therethough, which bore is adapted to receive a sound conducting tube or miniature speaker therein.

U.S. Pat. No. 3,811,437, issued May 21, 1974 and which was reissued as U.S. Pat. No. RE29,487 on Dec. 6, 1977 to Gardner, Jr., shows earplugs composed of certain polymeric foam materials. The earplugs are of generally cylindrical shape and of somewhat larger diameter than the human ear canal. The earplugs are composed of a foamed plasticized polymeric material having a sufficiently high concentration of plasticizer to provide the earplug with a reduced rate of recovery from compression. Gardner also provides novel ear insertable earpieces for lightweight earphone devices.

U.S. Pat. No. 4,724,922, issued Feb. 16, 1988 to Kalayjian, claims an acoustic earpiece of the type used to transmit sound mechanically from a sound source to the ear drum of a listener. The acoustic earpiece includes a tube and a resilient element surrounding one end thereof comprising an open cell resilient foam with a slow compression recovery rate and a fully compressed diameter of less than the diameter of the human ear canal.

U.S. Pat. No. 4,774,938, issued Oct. 4, 1988 to Leight, describes an earplug of the slow recovery type, which has open cells for expelling gas to the outside during compression, but which resists the entry of water through the outside and the soiling of the outside by dirt. The earplug includes a body formed of pressure-molded slow recovery resilient foam material forming multiple gas-filled shells. The plug body has a surface region forming a skin wherein the average cell cross-sectional area is less than half that of cells at the center of the body, and is less than one-tenth millimeter, the surface region being primarily continuous.

U.S. Pat. No. 4,434,794, issued Mar. 6, 1984 to Leight, provides an ear plug which includes a shell formed of closed cell foam material, with the shell surface having a multiplicity of small bumps that also form the walls of cells which lie at the surface of the shell, whereby to avoid wrinkling when the shell is squeezed into the ear canal. A stem of resilient material lies freely moveable in the shell, and is short so it extends substantially no further than the open end of the shell.

U.S. Pat. No. 5,080,110, issued Jan. 14, 1992 to Weldon et al, comprises an external ring, a radial collar, and a protruding portion which extends inside the ear canal to dampen sound. In the preferred embodiment, the collar and the exterior of the protruding portion are molded of a soft, flexible rubber, and the ring is made of a rigid plastic and includes an extending cylindrical core which inserts into the protrusion to make the two parts integral. The ear plug has a dual function, first, to conveniently permit insertion of the plug into the ear to the proper depth automatically and to prevent its easy removal, and secondly, to imitate as exactly as possible a scaled down version of a baby pacifier to enhance the ability to sell a pair of the units as novelty items.

U.S. Pat. No. 7,475,686, issued Jan. 13, 2009 to Knauer et al, shows an earplug comprising a foam composition containing a polyvinyl chloride resin and less than about 5 wt % monomeric phthalate, based on the total weight of the foam composition, is described. The foam composition may include a plasticizer containing less than or equal to about 2 wt % monomeric phthalate, based on the total weight of the plasticizer. The earplugs have slow recovery times from 60 percent compression to 10 percent compression of about 10 to about 60 seconds.

U.S. Pat. No. 6,006,857, issued Dec. 28, 1999 to Leight et al, is for an earplug of a type that includes a soft shell (12) and an insertion stem (16), which facilitates pullout of the earplug from the ear canal and which has an increased ability to block noise. The earplug includes a body or shell of soft elastomeric material with a forward portion (20) constructed to enter the ear canal and a rearward portion (22) which flares in a rearward direction. A stem (16) of more rigid material than the shell, extends along most of the length of a passage (14) formed within the shell. The shell passage has a neck part (42) at the rear of the shell forward portion. The stem has a forward flange (32) lying in interference fit within the passage at a location forward of the passage neck part, and the stem has a rearward flange (34) that lies in interference fit with the flared rear portion of the shell.

What is needed is a set of earphones comprising two outer shaped soft foam shell earphones with an inserted miniature speaker supported by a firm foam insert engaging with the outer shell for comfortable insertion and comfort during use conforming to the shape of the ear canal and ear around the ear canal to seal out external noise.

### BRIEF SUMMARY OF THE INVENTION

An object of the present invention is to provide a set of earphones comprising two outer shaped soft foam shell earphones with an inserted miniature speaker supported by a firm foam insert engaging with the outer shell for comfortable insertion and comfort during use conforming to the shape of the ear canal and ear around the ear canal to seal out external noise.

In brief, a set of earphones comprises two outer shaped soft foam shell earphones each having a bulbous insert head and flared outer rim separated by a narrow waist, each with an inserted miniature speaker supported by a firm foam insert engaging with the narrow waist, wherein the foam insert is used to push the earphone into the ear canal and the outer rim is used to withdraw the earphone, and wherein the miniature sound emitter is connected to a wire that connects to a sound jack plug. Sound from the miniature microphone enters the ear canal through an opening in the center of the bulbous end of the outer shell.

The foam outer shell conforms to the shape of the ear canal and the outer flared rim conforms to the ear surface surrounding the ear canal to seal the ear canal from outside sounds. The soft foam gently contacts the skin in the ear canal and the ear surface around the ear canal to be comfortably inserted into the ear canal and stay comfortably in the ear canal for long periods of time. A sound insulating plug inserted into the outer rim retains the miniature microphone within the outer shell and further assists in preventing outside sound from entering the ear canal.

The in-ear earphones of the present invention further comprise a miniature microphone stem of about the same length as the shell, and slideable within the shell, to facilitate insertion of the shell into the ear as well as providing sound into the ear canal out of the opening in the point. When the stem is pushed, its front end pushes on the front of the shell, to elongate the shell and thereby reduce its diameter to facilitate shell insertion into the ear canal. When the pushing force stops, the shell expands to conform to the shape of the ear canal. The rear of the shell flares away from the stem contacting the ear around the ear opening to assist in eliminating external sound from entering the ear canal and to facilitate grasping of the shell for removal.

The in-ear earphones of the present invention block external noise to increase enjoyment of whatever is transmitted through the in-ear earphones without the need to have a dangerous volume level, as is often the case in trying to drown out external noise, so that the listener enjoys what is played and bystanders can't hear what is being played.

Since the in-ear earphones of the present invention stay secured within the ear canal of the listener, the sound is greatly enhanced and the sound does not leak out to disturb bystanders.

The comfort of the in-ear earphones of the present invention permits long periods of listening without discomfort to the listener.

The shape of the in-ear earphones of the present invention enables them to conform to the shape of the ear canal for a comfortable secure fit.

The material of the present invention lasts a long time and is easy to clean.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is an elevational view of the shaped soft foam shell in-ear earphones of the present invention showing the miniature sound emitter held by a firm foam insert shown dashed inside the bulbous insert end with the foam insert engaging the waist of the foam shell and wires connecting the sound emitters to an acoustic plug;

FIG. 2 is an exploded perspective view of one of the shaped soft foam shell in-ear earphones of FIG. 1 showing the miniature sound emitter held by a firm foam insert and outer foam plug aligned for insertion in the soft foam shell with the wire extending from the sound transmitter to connect to the acoustic plug;

FIG. 3 is a perspective view of one of the shaped soft foam shell in-ear earphones of FIG. 1 showing the firm foam insert and outer foam plug in the soft foam shell with the wire extending out of the foam plug;

FIG. 4 is a cross-sectional view taken through a longitudinal centerline of one of the shaped soft foam shell in-ear earphones of FIG. 1 showing the miniature sound emitter held by a firm foam insert shown dashed inside the bulbous insert end with the foam insert engaging the waist of the foam shell and the outer foam plug inserted within the outer rim to retain the firm foam insert and miniature sound emitter therein and the wire extending out to connect the sound emitter to the acoustic plug;

FIG. 5 is an elevational view of the shaped soft foam shell in-ear earphones of the present invention showing the miniature sound emitter held by a firm foam insert shown dashed inside the bulbous insert end with the foam insert engaging the waist of the foam shell and a sound wave receiver for receiving sound remotely from a sound transmitter to transmit the sound to the miniature sound emitter;

FIG. 6 is an exploded perspective view of one of the shaped soft foam shell in-ear earphones of FIG. 5 showing the miniature sound emitter held by a firm foam insert and outer foam plug aligned for insertion in the soft foam shell and a sound wave receiver for receiving sound remotely from a sound transmitter to transmit the sound to the miniature sound emitter;

FIG. 7 is an elevational view of one the shaped soft foam shell in-ear earphones of FIG. 1 inserted in an ear canal of a user showing the miniature sound emitter held by a firm foam insert shown dashed inside the bulbous insert end with the foam insert engaging the waist of the foam shell and the wire draped over the back of the ear connecting the sound emitter to an acoustic plug.

### DETAILED DESCRIPTION OF THE INVENTION

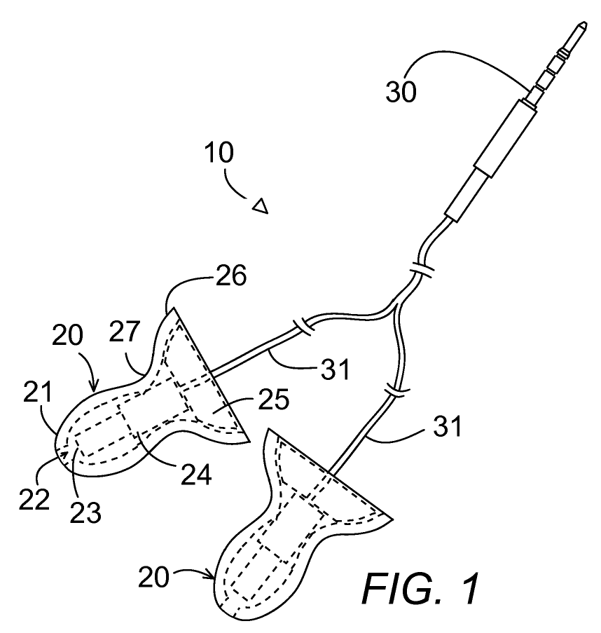

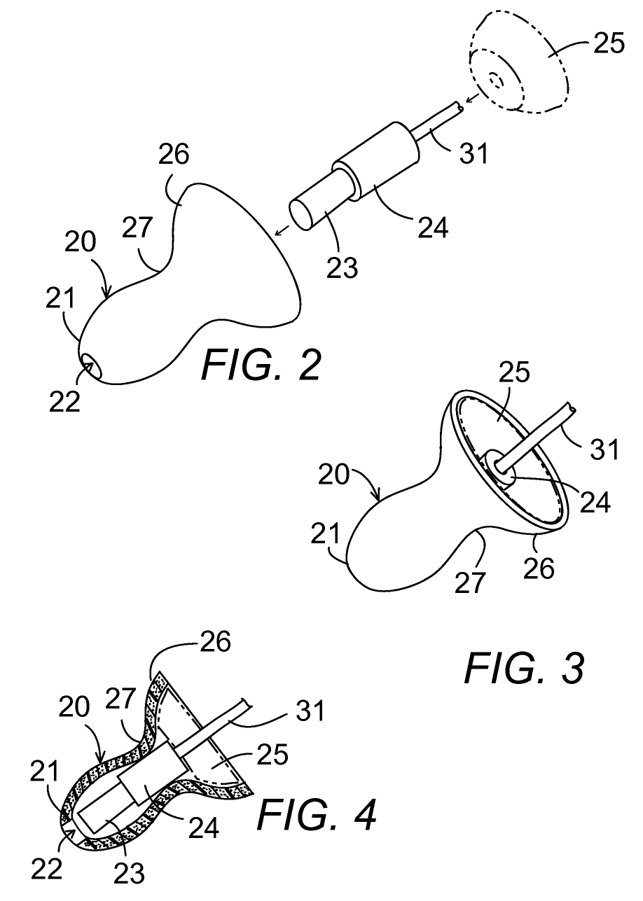

In FIGS. 1-7, an in-ear earphone device 10 of the present invention provides for a comfortable insertion and a secure comfort fit for extended comfortable use while sealing out outside sound from the ear canal 13.

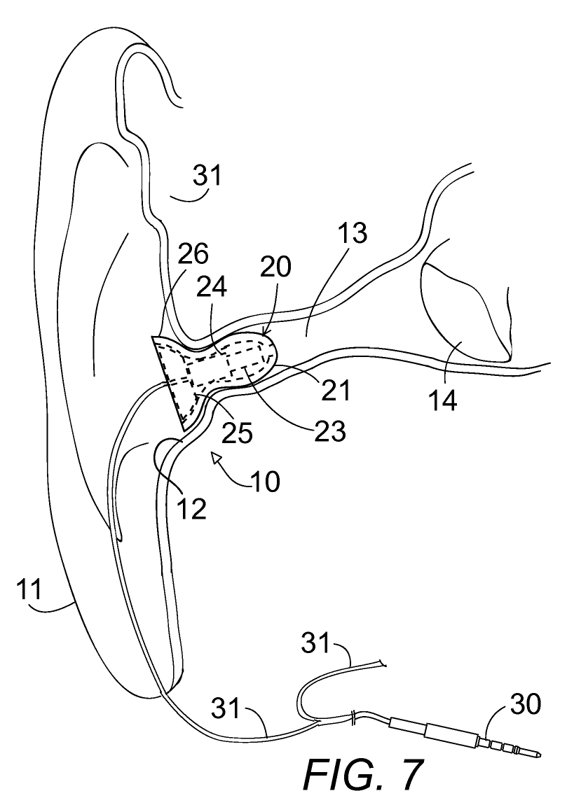

A pair of shaped soft outer foam shell earplugs 20 each have a bulbous insert head 21 conforming to a shape of an ear canal 13, as shown in FIG. 7, to secure the bulbous insert head therein and a flared outer rim 26 separated by a narrow waist 27 therebetween. The flared outer rim 26 conforms to the shape of the ear surface 12 surrounding the ear canal, as shown in FIG. 7. The foam shell earplugs 20 seal the ear canal 13 to prevent outside sound from entering the ear canal. Each of the bulbous insert heads 21 has a center end sound opening 22 for admitting sound from the interior of the foam shell earplug into the ear canal 13. The outer foam shell earplugs 20 have a foam sufficiently soft so that the foam shell earplugs 20 are easily inserted into the ear canal 13 without discomfort to the interior walls of the ear canal and so that the foam shell earplugs can remain securely in the ear canal for extended time periods without discomfort to the ear canal.

A miniature sound emitter 23 is inserted in each of the foam shell earplugs 20 inside the bulbous insert head 21 for transmitting sound into the ear canal 13 through the sound opening 22 to form an in-ear earphone device 10 which seals out outside sounds from the ear canal. The miniature sound emitter 23 is supported by a firm foam insert 24 engaging with the narrow waist 27 of the outer foam shell earplugs to seal the interior of the bulbous insert head from outside sound, as shown in FIG. 7. The foam insert 24 is sufficiently rigid along its length and coupled with the miniature sound emitter is used to push the bulbous insert head 21 into the ear canal 13 and the outer rim 26 is used to withdraw the earphone from the ear canal 13. the miniature sound emitter connected to means for receiving sound to transmit through the sound emitter;

A sound sealing outer plug 25 is inserted into each of the outer rims 26 to secure the miniature sound emitter 23 therein. The outer plug 25 conforms to the shape of the outer rim 26 to prevent outside sound from entering through the interior of the foam shell earplug 20. The present invention thereby provides an in-ear earphone device 10 for comfortable insertion and secure comfort fit for extended comfortable use while sealing out outside sound from the ear canal.

In FIGS. 1-4 and 7, the means for receiving sound to transmit through the sound emitter comprises a sound jack plug 30 removably connected to a sound producing device and a wire 31 connected between the sound jack plug 30 and each of the miniature sound emitters 23 to transmit sound between the sound producing device and the miniature sound emitters.

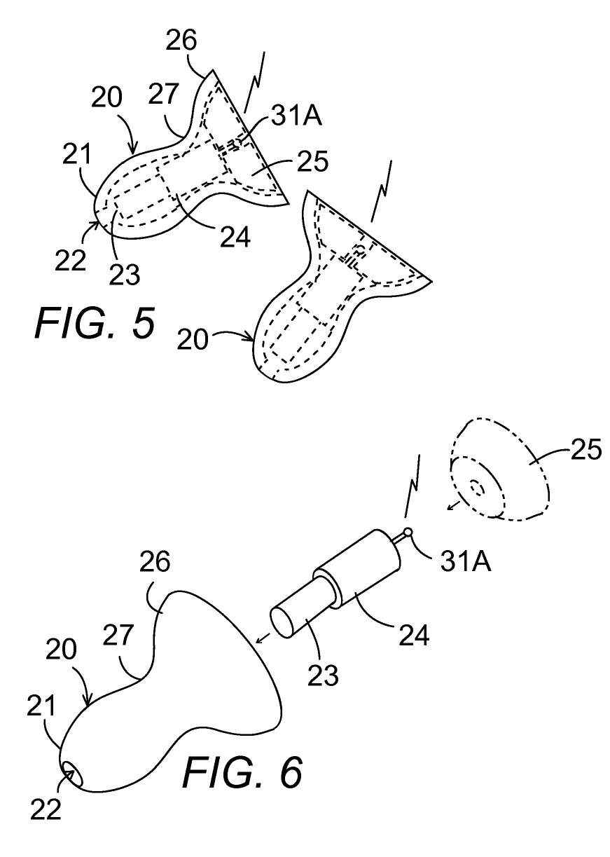

In FIGS. 5 and 6, the means for receiving sound to transmit through the sound emitter in each of the earphones comprises a sound wave receiver 31A communicating with a sound transmitter on a sound producing device, the sound wave receiver communicating with the miniature sound emitter 23 to transmit the sound into the ear canal 13.

The miniature sound emitter 23 may comprise a miniature sound speaker, an electronic sound emitter, a sound chip, or any other miniature device for emitting sound into the ear canal 13 to be picked up by the ear drum 14 and other components of the ear 11 used in picking up sound.

In use, the flared outer rim 26 is grasped in the fingers and squeezed together against the firm foam insert 24 and the bulbous insert head 21 is pushed into the ear canal until the flared outer rim 26 contacts the skin surface 12 surrounding the ear canal opening and the outer rim 26 released. The bulbous insert head 21 of the soft outer shell earplug 20 is pushed by the firm foam insert 24 and sound emitter 23 so that the bulbous insert head 21 is squeezed together as it passes through the opening to the ear canal and then expands out to contact the wall of the ear canal 13, as shown in FIG. 7, to seal the ear canal from outside sound and to retain the in-ear earphone device 10 securely without discomfort due to the soft foam gently contacting the skin. Upon release the outer rim 26 contacts the skin surface 12 of the ear 11 surrounding the ear canal opening to further seal the ear canal from outside sound, again without discomfort due to the soft foam gently contacting the skin.

After both in-ear earphone devices 10 are inserted, the sound plug 30 is then plugged into a sound jack to provide sound to the sound emitters 23 or the wireless sound wave receiver 31A is activated for sound.

To withdraw the in-ear earphone device 10 the outer rim 26 is grasped in the fingers and the device withdrawn from the ear canal.

The firm foam insert 24 holding the miniature microphone 23 is constructed of a fairly stiff but resilient material, such as neoprene closed cell foam material, so that the firm foam insert 24 is stiff enough to resist compression along its length, to facilitate insertion of the in-ear earphone, and yet can bend slightly laterally to enable the entire in-ear earphone to bend slightly to conform to the curvature of the ear canal when necessary.

The in-ear earphones of the present invention have many useful applications. The many uses of the present invention include listening to educational programs in schools and colleges, listening to recordings in libraries, listening to music or work related programs in the workplace, listening to sound devices in airports and other public places, and while traveling in planes, trains, buses, boats, cars, trucks and other vehicles, in hotels, at home, with computers, gaming devices, music devices, listening to movies, DVD players, CD players, MP3 players, GAMEBOYS, NINTENDO, and many other uses where private listening is desired without disturbing others and excluding the outside sound from the ear of the listener.

It is understood that the preceding description is given merely by way of illustration and not in limitation of the invention and that various modifications may be made thereto without departing from the spirit of the invention as claimed.

What is claimed is:

1. An in-ear earphone device for comfortable insertion and secure comfort fit for extended comfortable use while sealing out outside sound from the ear canal, the device comprising:
a pair of shaped soft outer foam shell earplugs each comprising a bulbous insert head conforming to a shape of an ear canal to secure the bulbous insert head therein and a flared outer rim separated by a narrow waist therebetween, the flared outer rim conforming to the shape of the ear surface surrounding the ear canal, the foam shell earplugs sealing the ear canal to prevent outside sound from entering the ear canal, each of the bulbous insert heads having a center end sound opening for admitting sound from the interior of the foam shell earplug into the ear canal, the outer foam shell earplugs having a foam sufficiently soft so that the foam shell earplugs are easily inserted into the ear canal without discomfort to the ear canal and so that the foam shell earplugs can remain securely in the ear canal for extended time periods without discomfort to the ear canal;
a miniature sound emitter inserted in each of the foam shell earplugs inside the bulbous insert head for transmitting sound into the ear canal through the sound opening to form an in-ear earphone which seals out outside sounds from the ear canal; the miniature sound emitter supported by a firm foam insert engaging with the narrow waist of the outer foam shell earplugs to seal the interior of the bulbous insert head from outside sound, wherein the foam insert is used to push the bulbous insert head into the ear canal and the outer rim is used to withdraw the earphone from the ear; the miniature sound emitter connected to means for receiving sound to transmit through the sound emitter;
a sound sealing outer plug inserted into each of the outer rims to secure the miniature sound emitter therein, the outer plug conforming to the shape of the outer rim to prevent outside sound from entering through the interior of the outer foam shell earplug, thereby providing an in-ear earphone device for comfortable insertion and secure comfort fit for extended comfortable use while sealing out outside sound from the ear canal.

2. The device of claim 1 wherein the means for receiving sound to transmit through the sound emitter comprises a sound jack plug removably connected to a sound producing device and a wire connected between the sound jack plug and each of the miniature sound emitters to transmit sound between the sound producing device and the miniature sound emitters.

3. The device of claim 1 wherein the means for receiving sound to transmit through the sound emitter in each of the earphones comprises a sound wave receiver communicating with a sound transmitter on a sound producing device, the sound wave receiver communicating with the miniature sound emitter to transmit the sound into the ear canal.

4. The device of claim 1 wherein the miniature sound emitter comprises a miniature sound speaker.
